(19) United States
(12) Patent Application Publication
(10) Pub. No.: US 2008/0127241 A1
(43) Pub. Date: May 29, 2008

(54) Community Program Ratings

(75) Inventor: Federico Garcea, Sunnyvale, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/532,424

(22) Filed: Sep. 15, 2006

(51) Int. Cl. H04N 7/173

(52) U.S. Cl. 725/24

(57) ABSTRACT

To store community program ratings, a rating for a program is received and an identification of whether the rating is a private rating for the user or is a rating that can be accessed by a plurality of other users is made. The rating and an indication of whether the rating is a private rating for the user or is a rating that can be accessed by a plurality of other users are sent to a community rating system for storage. To retrieve community program ratings, a request for a rating of a community for a program is received. User ratings for the program are accessed, the user ratings being ratings previously submitted by users in the community that were not identified as being private, and are presented to the user.

### BACKGROUND

The amount of television programming choices available to users has become very large. Cable and satellite systems provide many programming channels, and personal video recorders allow users to easily record and watch a large number of programs at the time(s) of their choice. Additionally, as video on demand systems increase in popularity, the number of programming choices will become even greater.

Although the large number of television programming choices is beneficial to users, it also creates problems because it can be difficult for users to decide which program(s) they might enjoy watching. Some programs are rated or reviewed by critics according to the critics' standards. However, users oftentimes do not know what the critics' standards are, or even whether they reflect their likes and dislikes. Thus, it would be beneficial to have a better way to give users program ratings to assist them in deciding which programs they might enjoy watching.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with certain aspects, a rating for a program is received and an identification of whether the rating is a private rating for the user or is a rating that can be accessed by a plurality of other users is made. The rating and an indication of whether the rating is a private rating for the user or is a rating that can be accessed by a plurality of other users are sent to a community rating system for storage.

In accordance with other aspects, a request for a rating of a community for a program is received. User ratings for the program are accessed, the user ratings being ratings previously submitted by users in the community that were not identified as being private, and are presented to the user.

### BRIEF DESCRIPTION OF THE DRAWINGS

The same numbers are used throughout the drawings to reference like features.

FIG. 1 illustrates an example environment in which embodiments of the community program ratings can be implemented.

FIG. 2 illustrates an example television-based system in which embodiments of the community program ratings can be implemented.

FIG. 3 is a flowchart illustrating an example process for inputting user ratings.

FIG. 4 is a flowchart illustrating an example process for presenting user ratings.

FIG. 5 illustrates an example IP-based television (IPTV) environment in which embodiments of the community program ratings can be implemented.

FIG. 6 illustrates various components of an example client device in which embodiments of the community program ratings can be implemented.

FIG. 7 illustrates an example entertainment and information system in which an IP-based television environment can be implemented, and in which embodiments of the community program ratings can be implemented.

FIG. 8 illustrates an example of a general computing device that can be used to implement at least portions of the community program ratings discussed herein.

### DETAILED DESCRIPTION

Community program ratings are discussed herein. Users can enter their ratings for programs and select which other users, such as members of a particular community, can access those ratings. These ratings can also be subsequently accessed by other users in that community.

While aspects of the described systems and methods for community program ratings can be implemented in any number of different computing systems, environments, television-based entertainment systems, and/or configurations, embodiments of community program ratings are described in the context of the following example systems and environments.

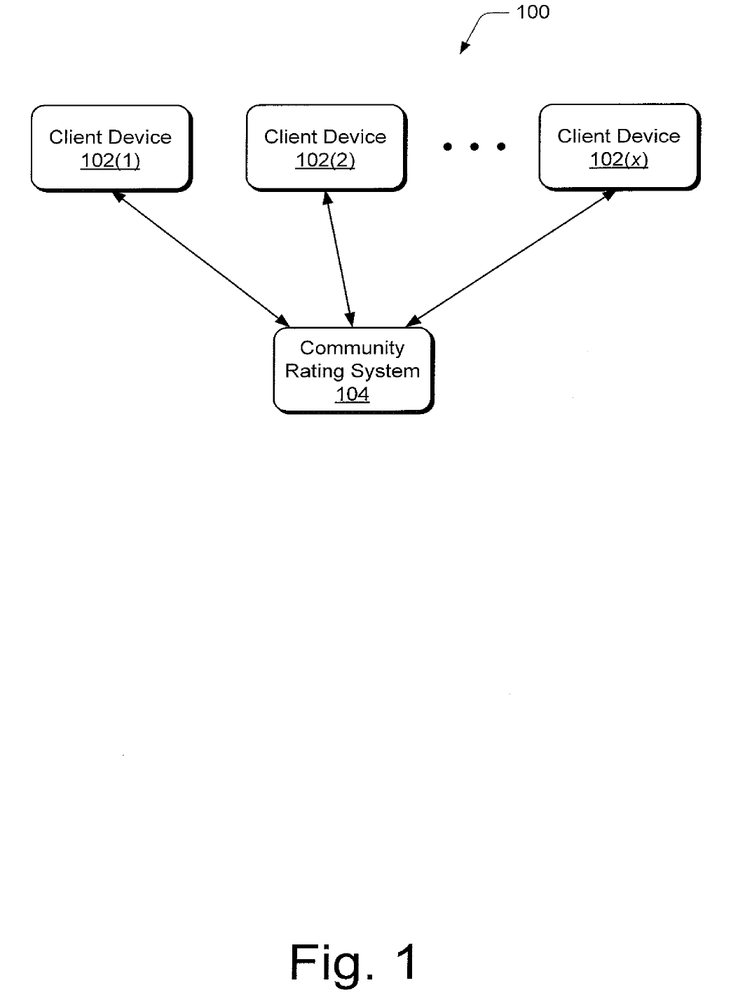

FIG. 1 illustrates an example environment 100 in which embodiments of the community program ratings can be implemented. As used herein, a “program” refers to any television program, movie, commercial, musical piece, on-demand and/or broadcast media content, and any similar audio, video, and/or image media content.

Environment 100 includes multiple (x) client devices 102(1), 102(2), . . . , 102(x) and a community rating system 104. Client devices 102 are any of a variety of devices that can be used to present a program to a user. Examples of a client device 102 include a television, a television-based set-top box, a digital video recorder (DVR) and playback system, an appliance device, a gaming system, a computer (such as a desktop computer), and so forth. Client devices 102 in environment 100 can be different types of device, or one or more of client devices 102 can be the same type of device.

Community rating system 104 communicates with client devices 102. Ratings submitted by the users of client devices 102 are sent to community rating system 104, which receives the ratings. Community rating system 104 stores the ratings, and responds to requests from client devices 102 for the ratings. Community rating system 104 can be implemented as one or more computing devices. Additionally, although illustrated as a system separate from client devices 102, community rating system 104 may be implemented as a distributed system spread across client devices 102.

As used herein, a “rating” refers to a value on a rating scale, which can take any of a variety of different forms. A user can enter a rating for a program to indicate how well he or she likes the program. Any of a variety of different publicly available rating scales or custom scales can be used. For example, the rating scale may be numeric (e.g., a range of 1 to 10, with a value of 1 indicating the user did not like the program, and a value of 10 indicating the user liked the program very much). By way of another example, the rating scale may be stars, circles, roses, or any other shape or image, with a larger number of these shapes or images being associated with a higher rating on the scale. By way of yet another example, the rating scale may be binary (e.g., recommended or not recommended, thumbs up or thumbs down, good or bad, and so forth).

Each user of a client device 102 can be part of one or more communities. These communities can be customized by users to include only those users that they desire. For example, a community of friends could be created, a community of family members could be created, and so forth. These communities can be created manually (e.g., by a user entering identifiers of the members of the community), or alternatively can be created based at least in part on a pre-existing group of users (e.g., a buddy or friends list used in instant messaging or online gaming, an email address book, and so forth). Each user that is part of a community has a corresponding identifier that allows the individual to be uniquely identified. This identifier can be, for example, an email address, a gamer tag or id, or any other user name that allows the users to be uniquely identified.

During operation, a user of client device 102 inputs at client device 102 a rating for a program. This rating may be input by the user upon completion of watching the program, while watching the program, or alternatively at some other time. For example, the user may browse through an electronic programming guide (EPG) at the client device and rate programs as he or she browses through them.

Users can rate programs individually. For example, the user can rate a program as he or she watches the program, or can select a program from a list (such as an EPG) or from searching through a database of programs and rate that selected program individually. Additionally, groups of programs can be rated together by the user. For example, a series of programs (e.g., a particular sitcom, a particular sports team, a particular news show or talk show, and so forth) can be ranked together by the user. The user can select one particular program from the series, and input an indication (e.g., such as by selection of an on-screen option) that the rating is to apply to all programs in that series.

Associated with the rating, the user may also input comments regarding the program. These comments are typically text comments or verbal comments, although other visual and/or audible comments may alternatively be input. These comments, along with the rating input by the user, are sent from client device 102 to community rating system 104.

In addition to inputting the rating and optionally comments, the user also identifies which of multiple other users can access the rating and any associated comments. This identification of which other users can access the rating is associated with the rating. In certain embodiments, the user is able to choose between keeping the rating private and making the rating available to the community. If the rating is kept private, then it is accessible to only that user, no others. If the rating is made available to the community, then the rating is accessible to that user as well as any other users in the community. In certain situations a user may be able to be a part of multiple communities, in which case if the rating is made available to the community then the user can also select which one or more of the multiple communities the rating is accessible to.

In certain embodiments, the user can also choose to make the rating public. If the rating is made public, then the rating is accessible to all users regardless of the community or communities they are part of.

Community rating system 104 receives the user's rating for the program as well as other information associated with the program (any comments regarding the program, and an indication of whether the rating is private, is available to the community (or communities), or public). All of this received information is associated with the user identifier of the user submitting the rating, and is stored by community rating system 104. This association between the user identifier and the user's rating (as well as the other information associated with the rating) is maintained by community rating system 104 to allow the rating to be subsequently retrieved by other users.

When a user of a client device 102 desires to receive a rating for a program, a request for the rating for the program is sent to community rating system 104. Community rating system 104 maintains, for each user, an indication of which communities he or she is part oft as well as the other users that are part of that community (or those communities). Community rating system 104 receives the request for the program rating and identifies the community or communities that the requesting user is part of. Community rating system 104 then accesses the program ratings that it has stored for each user in that community (or those communities) and determines whether any of those users have rated the program. Any ratings, as well as any associated comments, from the other users for that program that are not indicated as being private ratings are returned to the requesting user.

The ratings can be returned to the requesting user in different manners. In certain embodiments, the individual ratings are presented to the user, optionally with an identifier of the user that gave each rating. For example, if five different users in the community rated the program, then those five individual ratings would be presented to the requesting user (optionally along with the identifiers of each of the five users). In other embodiments community rating system 104 (or alternatively client device 102) consolidates the multiple individual ratings into a single rating that is presented to the requesting user (optionally with comments associated with the individual ratings). The manner in which the individual ratings are consolidated can vary depending on the form of the ratings. For example, if the ratings are numbers (e.g., on a scale 1 to 10), then the ratings can be consolidated by averaging the individual rating numbers.

Additionally, rather than requesting a rating for a particular program, a user could request all of the ratings for a community they are part of. In response to such a request, community rating system 104 returns all of the ratings that have been submitted by the users in that community rather than just the ratings for a particular program. These ratings can be presented to the user in different manners, such as in an EPG format, a list of programs (organized alphabetically by program title, organized by user identifier, etc.), and so forth. Alternatively, rather than requesting the ratings for all users in the community, the user may request only the ratings from particular users in the community.

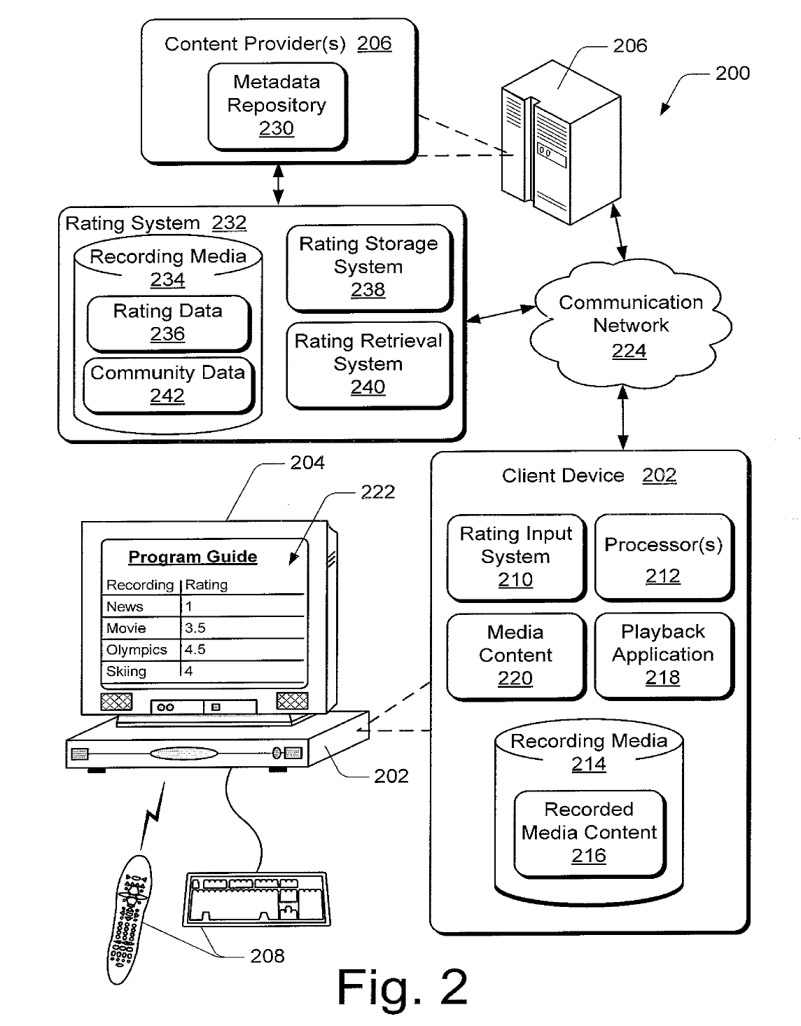

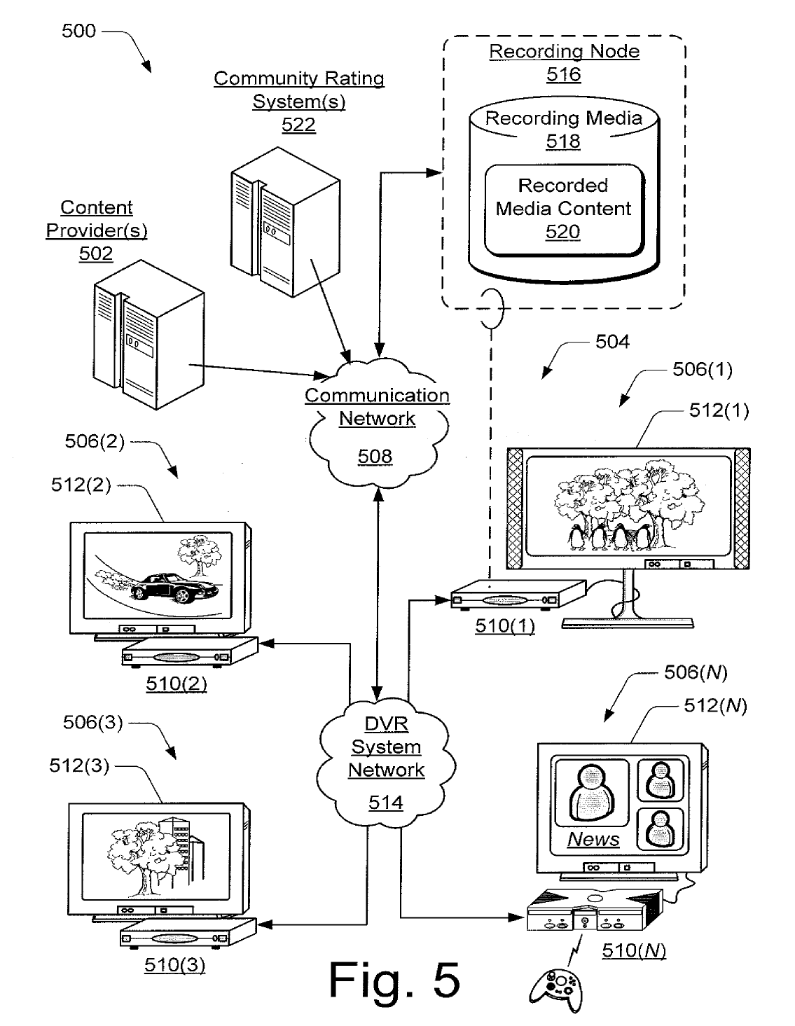

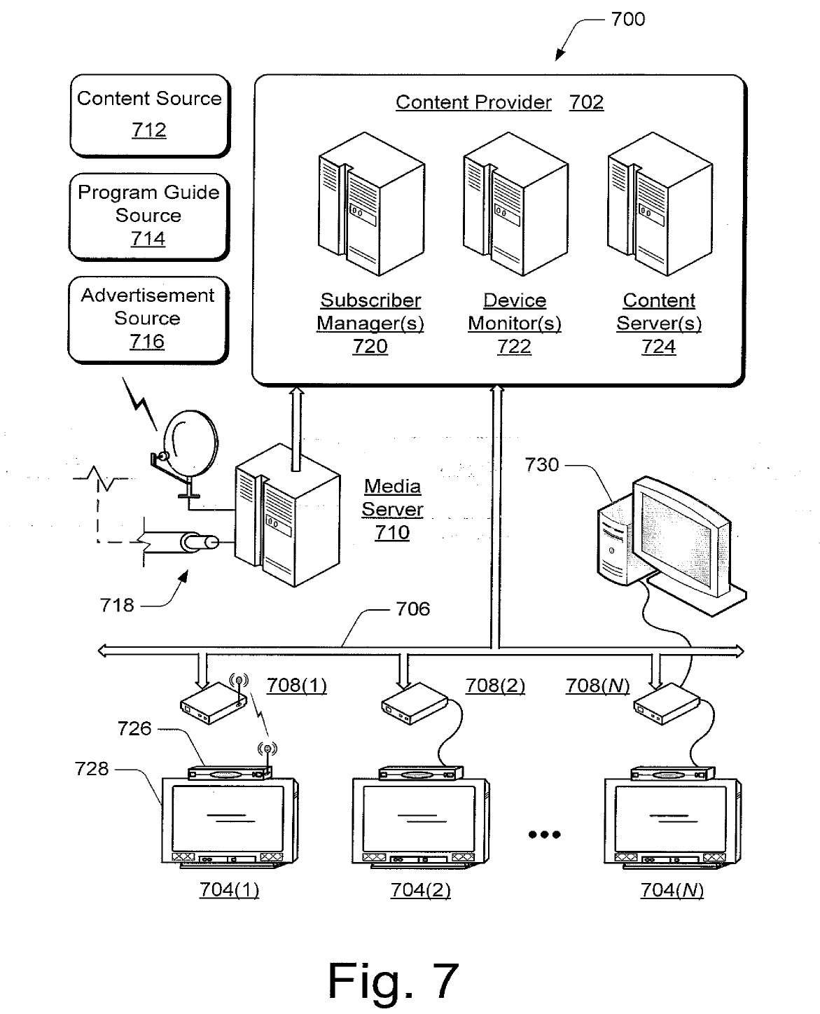

FIG. 2 illustrates an example television-based system 200 in which embodiments of the community program ratings can be implemented. System 200 includes television-based client device 202, display device 204, content provider(s) 206, input devices 208 (such as a remote control device and a computer keyboard), and rating system 232. Display device 202 can be any type of television, LCD, or similar television-based display system that renders audio, video, and/or image data. Client device 202 and display device 204 together are but one example of a television-based client system, examples of which are described with reference to the example IP-based television (IPTV) system 500 shown in FIG. 5, and with reference to the example entertainment and information system 700 shown in FIG. 7. Client device 202 can be, for example, client device 102 of FIG. 1.

Client device 202 can be implemented in any number of embodiments, such as a set-top box, a digital video recorder (DVR) and playback system, an appliance device, a gaming device, and as any other type of client device that may be implemented in a television-based entertainment and information system. In this example, client device 202 includes rating input system 210 that is associated with the viewer (user) at client device 202. Rating input system 210 receives user ratings and associated information from a viewer or user of client device 202 and communicates the received ratings and information to rating system 232.

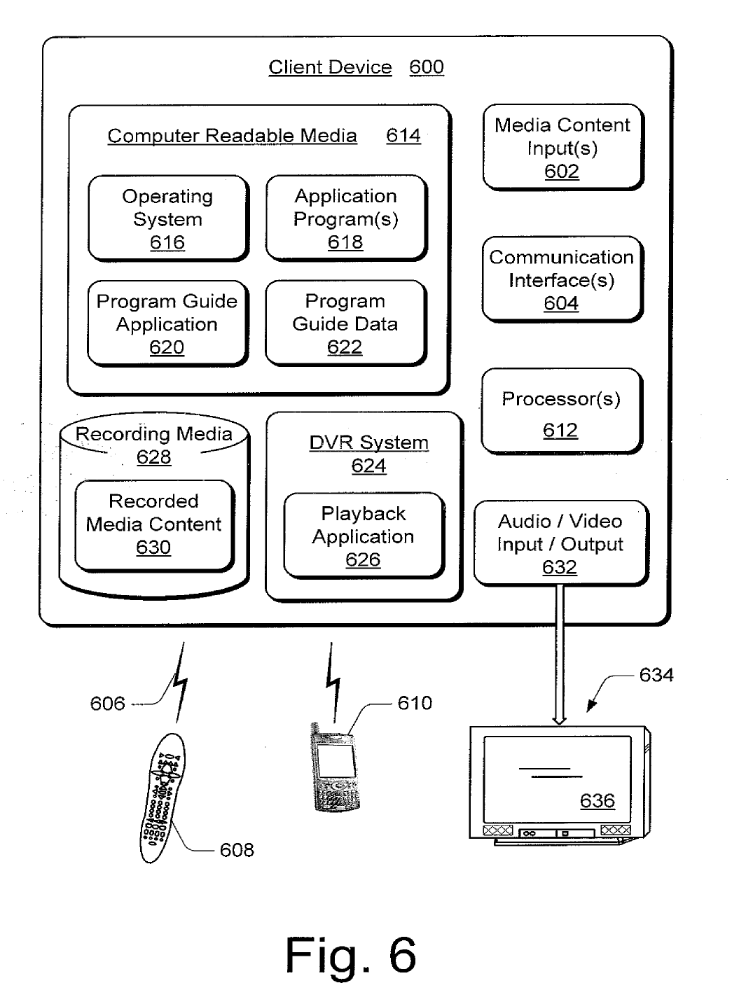

Client device 202 also includes one or more processor(s) 212, recording media 214 that maintains recorded media content 216, and playback application 218 which can be implemented as computer executable instructions and executed by processor(s) 212 to implement embodiments of content ratings and recommendations. Additionally, client device 202 may be implemented with any number and combination of differing components as further described below with reference to the example client device 600 shown in FIG. 6.

Recording media 214 along with playback application 218 can be implemented as a DVR system to record and maintain recorded media content 216 which may be any form of on-demand and/or broadcast media content 220 such as a program that client device 202 receives and/or records. Further, client device 202 may access or receive additional recorded media content that is maintained with a remote data store (not shown), such as from a video-on-demand server, or media content that is maintained at a broadcast center or content provider that distributes the media content to subscriber sites and client devices.

Playback application 218 is a video control application that, in this example, can be implemented to control the playback of media content 220, the recorded media content 216, and or other video on-demand media content, music, and any other audio, video, and/or image media content which can be rendered and/or displayed for viewing on display device 204, such as program guide 222. In this example, program guide 222 includes the community program ratings for a viewer that utilizes television-based client device 202.

Television-based client device 202 is configured for communication with content provider(s) 206 via a communication network 224, which in this example, is an IP-based network. Client device 202 receives programs, associated program content, various forms of media content, program guide data, advertising content, and other media content from content server(s) of content provider(s) 206 via IP-based network 224.

Content provider 206 can also include a metadata repository 230 that contains the listings and metadata information provided by the television and movie industry. Content provider 206 can also receive program ratings from rating system 232, which in certain embodiments is community rating system 104 of FIG. 1. The metadata information in repository 230 can be supplemented with ratings and associated information from rating system 232. Alternatively, rating system 232 may communicate with client devices 202 directly via communication network 224 rather than through content provider 206.

Rating system 232 can be, for example, community rating system 104 of FIG. 1. When a user adds a rating to a program, that rating is communicated to rating system 232. Rating system 232 collects the rating and any associated information and stores it, as discussed above. Rating system 232 includes recording media 234 that maintains rating data 236 and community data 242, rating storage system 238, and rating retrieval system 240. Program ratings are received from client device 202 by rating storage system 238, which stores the received ratings as rating data 236. An identifier of the user that submitted the rating is also stored on recording media 234, as are any comments associated with the rating.

The different communities as well as which users (based on their user identifiers) are part of which communities is maintained as rating data 236. When client device 202 requests a program rating, rating retrieval system 240 identifies the community or communities that the requesting user is part of from community data 242. Rating retrieval system 240 then identifies the other users that are part of that community or communities, and obtains the ratings from rating data 236 for the requested program from the users in that community or communities.

Content provider 206 and/or rating system 232 can provide the program ratings to the viewers by communicating the information to the television-based client device 202 either in-band along with a program or broadcast, out-of-band, or a combination of both. Alternatively, a program identifier can be communicated from content provider 206 to the television-based client device 202 which the client device then utilizes to request the corresponding rating information from content provider 206, or other similar data repository.

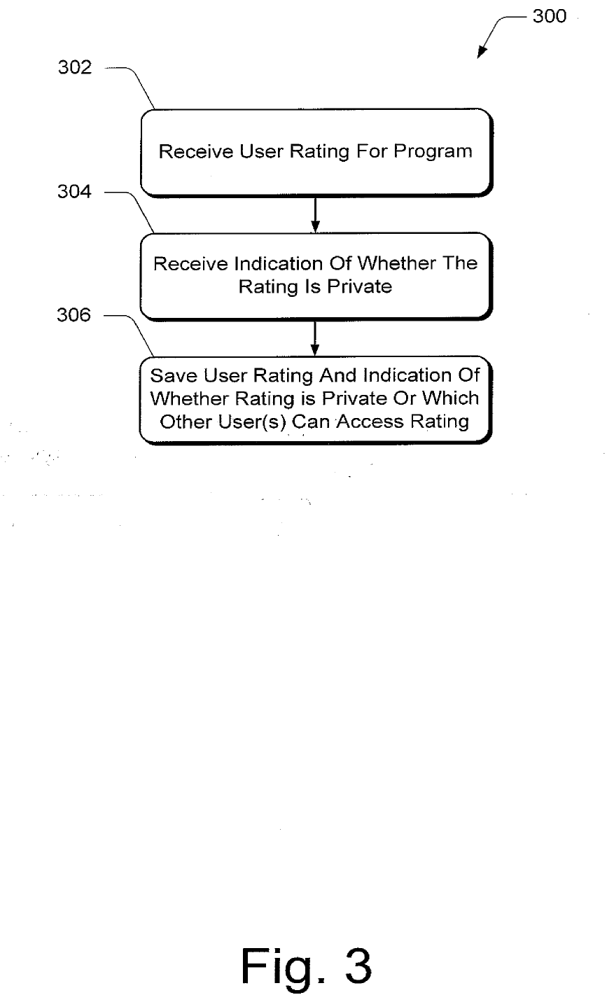

FIG. 3 is a flowchart illustrating an example process 300 for inputting user ratings. Process 300 is carried out by, for example, a client device 102 and community rating system 104 of FIG. 1. Process 300 can be implemented in software, firmware, hardware, or combinations thereof.

Initially, a user rating for a program is received (act 302). The user rating is input by a user at client device 102 using any of a variety of different input mechanisms (e.g., an input device 208 of FIG. 2). Additional comments associated with the user rating as discussed above may also be received along with the user rating in act 302.

An indication of whether the rating input in act 302 is private is also received (act 304). This indication identifies whether the rating is private so no other users can access the rating, or identifies which other user(s) can access the rating. If the rating is not private, then the indication identifies whether the rating is available to a community (and optionally an indication of which one or more of multiple communities the rating is available to), or an indication that the rating is made public. This indication of whether the rating is private can be specifically identified in act 304, such as by the user selecting a “private” option by way of an input device (e.g., an input device 208 of FIG. 2) to indicate that the rating is private so no other users can access the rating. If the rating is not private, then the indication of which other user(s) can access the rating can be specifically identified in act 304, such as by the user selecting one or more communities by way of an input device (e.g., an input device 208 of FIG. 2) that the rating is to be made available to.

Additionally, a default value(s) may be set so that the indication of whether the rating is private (or which other user(s) can access the rating input by the user) is automatically associated with the rating when the rating is received in act 302. For example, the default may be that each rating input by the user is private, but the user can override the private setting by making a selection that the rating is to be made available to the community. Such a default value(s) can optionally be changed by the user when he or she desires.

The user rating and the indication of whether the rating is private or which other user(s) can access the rating is then saved (act 306). Any comments associated with the rating are also saved in act 306. This saving is performed by communicating the user rating and the indication of whether the rating is private or which other user(s) can access the rating to rating system 232 for storage.

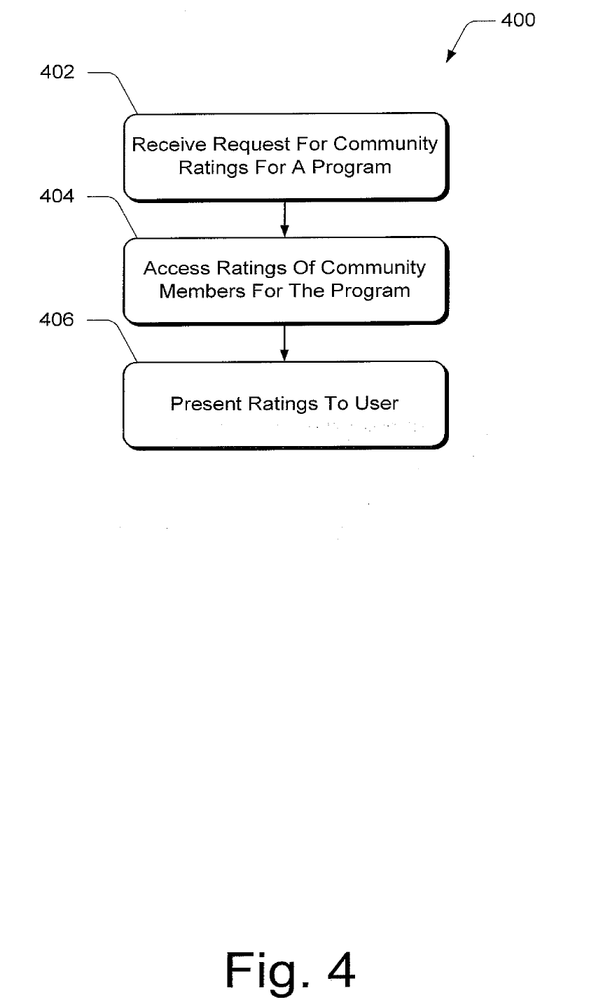

FIG. 4 is a flowchart illustrating an example process 400 for presenting user ratings. Process 400 is carried out by, for example, a client device 102 and community rating system 104 of FIG. 1. Process 400 can be implemented in software, firmware, hardware, or combinations thereof.

Initially, a request for community ratings for a program is received (act 402). This request can be input explicitly by a user to a client device 102, such as by entering a search request through an input device (e.g., an input device 208 of FIG. 2). This request can also be input implicitly by a user to a client device 102, such as by selection of an option that results in community ratings being displayed. For example, the user may request that the EPG be displayed, and the EPG may include the community ratings. By way of another example, the user may enter a search request to search for a program in a program database (e.g., by title, by keywords, by actors/actresses, and so forth). The results of this search request can include the community ratings.

In response to the request received in act 402, the user ratings for the program previously input by other users in the requesting user's community and stored by rating system 104 are accessed (act 404). These returned ratings are only those ratings that are input by the users in the requesting user's community, and does not include ratings that were input by other users and indicated as being private. These returned ratings can optionally include ratings previously submitted by the requesting user. Additionally, in certain embodiments, the user can request that all public ratings be returned as well.

The ratings accessed in act 404 are then presented to the requesting user (act 406). As discussed above, these ratings may be presented to the user individually, or alternatively may be consolidated into a single rating. Any comments associated with the ratings are also presented to the user. Additionally, as discussed above, the user identifiers of the other users that submitted ratings for the program may be presented to the user in act 406.

FIG. 5 illustrates an example IP-based television (IPTV) environment 500 in which embodiments of the community program ratings can be implemented. IPTV environment 500 includes content provider(s) 502 and a multi-DVR system 504 that can include any number of television-based client systems 506(1-N). Multi-DVR system 504 can represent a household viewing system that has several viewing areas, such as different rooms, for viewing television programs. Multi-DVR system 504 is configured for communication with any number of the different content provider(s) 502 and community rating system(s) 522 via a communication network 508 which, in this example, is an IP-based network. Any of the systems and/or devices can be configured for network access in any number of embodiments and varieties of implementation. Community rating system(s) 522 can be, for example, community rating system 104 of FIG. 1 or rating system 232 of FIG. 2.

Television-based client systems 506(1-N) of multi-DVR system 504 are representative of DVR nodes in a multi-DVR system. Each of the DVR nodes of multi-DVR system 504 can communicate with each other to act and make decisions on behalf of the other nodes, for the overall common good of multi-DVR system 504, and based on the state of individual nodes and/or based on the state of multi-DVR system 504.

Television-based client system 506(1) includes a television-based client device 510(1) and a display device 512(1), such as any type of television, monitor, LCD, or similar television-based display system that together renders audio, video, and/or image data. Similarly, television-based client systems 506(2-N) each include a respective television-based client device 510(2-N) and a respective display device 512(2-N). Each television-based client device 510 can be implemented in any number of embodiments, such as a television-based set-top box, a digital video recorder (DVR) and playback system, an appliance device, a gaming system such as client device 510(N), and as any other type of client device that may be implemented in a television-based entertainment and information system.

Television-based client devices 510(1-N) of television-based client systems 506(1-N) can be implemented for communication with each other via a DVR system network 514, and may be implemented with any number and combination of differing components as further described below with reference to the example client device shown in FIG. 6. Further, IPTV environment 500 may be implemented with any number and combination of differing components as described below with reference to the example entertainment and information system shown in FIG. 7.

A television-based client system 506 at a node of multi-DVR system 504 can receive programs, user ratings, associated program content, various forms of media content, program guide data, advertising content, and other types of media content from content server(s) of content provider(s) 502 via communication network 508. Television-based client system 506 may also communicate data, such as user ratings, to community rating system 104 via communication network 508. Media content can include television-based programs (or programming) which may be any form of programs, commercials, music, movies, and video on-demand movies. Other media content can include recorded media content, interactive games, network-based applications, and any other similar audio, video, and/or image content. In addition, media content in general may include music streamed from a computing device to a client device, such as a television-based set-top box, and may also include video on-demand media content delivered from a server, a photo slideshow, and any other audio, video, and/or image content received from any type of media content source.

Although the data streams are not shown specifically, the arrowed communication links illustrate various data communication links which include the data streams. Additionally, the arrowed communication links are not intended to be interpreted as a one-way communication link from DVR system network 514 to a client device 510(1), for example. It is contemplated that any one or more of the arrowed communication links can facilitate two-way data communication, such as from communication network 508 to a content provider 502.

Multi-DVR system 504 includes a recording node 516 which includes a recording media 518 to maintain recorded media 520. In an embodiment, any one or more of the television-based client devices 510(1-N) in multi-DVR system 504 can be implemented as recording node 516 (as shown by the dashed line) which includes recording media 518 to record media content received from a content provider 502. Alternatively (or in addition), a recording node of multi-DVR system 504 can be implemented as a network-based recording node that multi-DVR system 504 can communicate with via communication network 508. In another implementation, recording node 516 can be an independent component of multi-DVR system 504.

Recording node 516 can record media content with recording media 518 for any one or more of television-based client devices 510(1-N) of multi-DVR system 504. For example, a television-based client device 510 can initiate a record request to have media content recorded for a scheduled recording or to record and provide a pause buffer for the television-based client device. Recording node 516 can receive the record request and record the media content such that the television-based client device can access and render the recorded media content from the recording node via DVR system network 514 and/or communication network 508.

FIG. 6 illustrates various components of an example client device 600 which can be implemented as any form of a computing, electronic, or television-based client device in which embodiments of the community program ratings can be implemented. For example, client device 600 can be implemented as a television-based client device at a DVR node of the multi-DVR system shown in FIG. 5.

Client device 600 includes one or more media content inputs 602 which may include Internet Protocol (IP) inputs over which streams of media content are received via an IP-based network. Device 600 further includes communication interface(s) 604 which can be implemented as any one or more of a serial and/or parallel interface, a wireless interface, any type of network interface, a modem, and as any other type of communication interface. A wireless interface enables client device 600 to receive control input commands 606 and other information from an input device, such as from remote control device 608, a portable computing-based device (such as a cellular phone) 610, or from another infrared (IR), 802.11, Bluetooth, or similar RF input device.

A network interface provides a connection between client device 600 and a communication network by which other electronic and computing devices can communicate data with device 600. Similarly, a serial and/or parallel interface provides for data communication directly between client device 600 and the other electronic or computing devices. A modem facilitates client device 600 communication with other electronic and computing devices via a conventional telephone line, a DSL connection, cable, and/or other type of connection.

Client device 600 also includes one or more processors 612 (e.g., any of microprocessors, controllers, and the like) which process various computer executable instructions to control the operation of device 600, to communicate with other electronic and computing devices, and to implement embodiments of multi-DVR node communication. Client device 600 can be implemented with computer readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 614 provides data storage mechanisms to store various information and/or data such as software applications and any other types of information and data related to operational aspects of client device 600. For example, an operating system 616 and/or other application programs 618 can be maintained as software applications with computer readable media 614 and executed on processor(s) 612 to implement embodiments of multi-DVR node communication and community program ratings.

For example, client device 600 can be implemented to include a program guide application 620 that is implemented to process program guide data 622 and generate program guides for display which enable a viewer to navigate through an onscreen display and locate broadcast programs, recorded programs, video on-demand programs and movies, interactive game selections, network-based applications, and other media access information or content of interest to the viewer.

Client device 600 can also include a DVR system 624 with playback application 626, and recording media 628 to maintain recorded media content 630 which may be any form of on-demand and/or media content such as programs, movies, commercials, music, and similar audio, video, and/or image content that client device 600 receives and/or records. Further, client device 600 may access or receive additional recorded media content that is maintained with a remote data store (not shown), such as from a video-on-demand server, or media content that is maintained at a broadcast center or content provider that distributes the media content to subscriber sites and client devices. Playback application 626 is a video control application that can be implemented to control the playback of media content, recorded media content 630, and or other video on-demand media content, music, and any other audio, video, and/or image media content which can be rendered and/or displayed for viewing.

Client device 600 also includes an audio and/or video output 632 that provides audio and video to an audio rendering and/or display system 634, or to other devices that process, display, and/or otherwise render audio, video, and image data. Video signals and audio signals can be communicated from device 600 to a display device 636 via an RF (radio frequency) link, S-video link, composite video link, component video link, analog audio connection, or other similar communication link. Alternatively, the audio rendering and/or display system 634 is/are integrated components of the example client device 600.

FIG. 7 illustrates an example entertainment and information system 700 in which an IP-based television environment can be implemented, and in which embodiments of the community program ratings can be implemented. System 700 facilitates the distribution of media content, program guide data, and advertising content to multiple viewers and to multiple viewing systems. System 700 includes a content provider 702 and television-based client systems 704(1-N) each configured for communication via an IP-based network 706. Each television-based client system 704(1-N) is an example of television-based client systems 506(1-N) described with reference to FIG. 5. Each of television-based client systems 704(1-N) can receive one or more data streams from content provider 702 which are then distributed to one or more other television-based client devices at DVR nodes of a multi-DVR system.

Network 706 can be implemented as a wide area network (e.g., the Internet), an intranet, a Digital Subscriber Line (DSL) network infrastructure, or as a point-to-point coupling infrastructure. Additionally, network 706 can be implemented using any type of network topology and any network communication protocol, and can be represented or otherwise implemented as a combination of two or more networks. A digital network can include various hardwired and/or wireless links 708(1-N), routers, gateways, and so on to facilitate communication between content provider 702 and client systems 704(1-N). Television-based client systems 704(1-N) receive media content, program content, program guide data, advertising content, closed captions data, and the like from content server(s) of content provider 702 via IP-based network 706.

System 700 includes a media server 710 that receives media content from a content source 712, program guide data from a program guide source 714, and advertising content from an advertisement source 716. In an embodiment, media server 710 represents an acquisition server that receives the audio and video media content from content source 712, an EPG server that receives the program guide data from program guide source 714, and/or an advertising management server that receives the advertising content from advertisement source 716.

Content source 712, program guide source 714, and advertisement source 716 control distribution of the media content, the program guide data, and the advertising content to media server 710 and/or to other television-based servers. The media content, program guide data, and advertising content is distributed via various transmission media 718, such as satellite transmission, radio frequency transmission, cable transmission, and/or via any number of other wired or wireless transmission media. In this example, media server 710 is shown as an independent component of system 700 that communicates the program content, program guide data, and advertising content to content provider 702. In an alternate implementation, media server 710 can be implemented as a component of content provider 702.

Content provider 702 is representative of a headend service in a television-based content distribution system, for example, that provides the media content, program guide data, and advertising content to multiple subscribers (e.g., the television-based client systems 704(1-N)). Content provider 702 can be implemented as a satellite operator, a network television operator, a cable operator, and the like to control distribution of media content, program and advertising content, such as movies, television programs, commercials, music, and other audio, video, and/or image content to client systems 704(1-N).

Content provider 702 includes various components to facilitate media data processing and content distribution, such as a subscriber manager 720, a device monitor 722, and a content server 724. Subscriber manager 720 manages subscriber data, and device monitor 722 monitors client systems 704(1-N) (e.g., and the subscribers), and maintains monitored client state information.

Although the various managers, servers, and monitors of content provider 702 (to include media server 710 in one embodiment) are illustrated and described as distributed, independent components of content provider 702, any one or more of the managers, servers, and monitors can be implemented together as a multi-functional component of content provider 702. Additionally, any one or more of the managers, servers, and monitors described with reference to system 700 can implement features and embodiments of multi-DVR node communication.

Program ratings can be incorporated into various content and/or data that is provided, for example, by program guide source 714. The program ratings can be incorporated by media server 710, content provider 702, or by a client system(s) 704(1-N). The program ratings may also be provided directly to client system(s) 704(1-N) rather than being routed through media server 710 and/or content provider 702.

The television-based client systems 704(1-N) can be implemented to include a television-based client device 726 and a display device 728 (e.g., a television, LCD, and the like). A television-based client device 726 of a television-based client system 704 can be implemented in any number of embodiments, such as a set-top box, a digital video recorder (DVR) and playback system, an appliance device, a gaming system, and as any other type of client device that may be implemented in a television-based entertainment and information system. In an alternate embodiment, client system 704(N) is implemented with a computing device 730 as well as a television-based client device 726. Additionally, any of the television-based client devices 726 of a television-based client system 704 can implement features and embodiments of multi-DVR node communication as described herein.

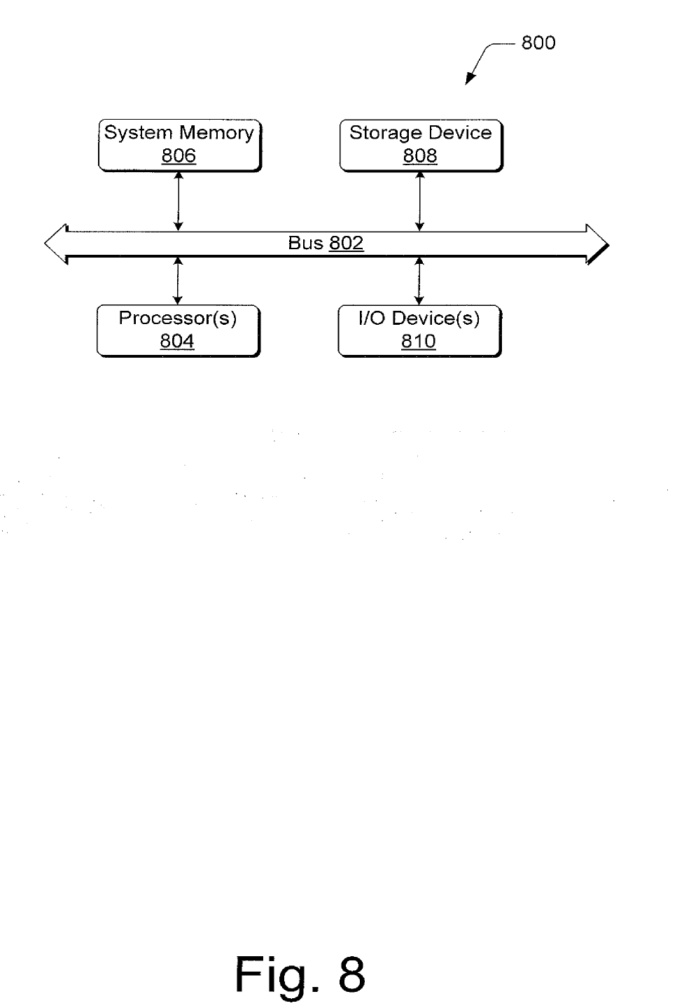

FIG. 8 illustrates an example of a general computing device 800 that can be used to implement at least portions of the community program ratings discussed herein. Computing device 800 can be, for example, a client device 102 or a community rating system 104 of FIG. 1. Computing device 800 is only one example of a computing device and is not intended to suggest any limitation as to the scope of use or functionality of the computing device and network architectures. Neither should computing device 800 be interpreted as having any requirement regarding the inclusion (or exclusion) of any components or the coupling or combination of components illustrated in the example computing device 800.

Computing device 800 is a general-purpose computing device that can include, but is not limited to, one or more processors or processing units 804, a system memory 806, and a bus 802 that couples various system components including the processor 804 to the system memory 806.

Bus 802 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

System memory 806 includes computer readable media in the form of volatile memory, such as random access memory (RAM), and/or non-volatile memory, such as read only memory (ROM) 812.

Computing device 800 may also include other removable/non-removable, volatile/non-volatile computer storage device 808. By way of example, storage device 808 may be one or more of a hard disk drive for reading from and writing to a non-removable, non-volatile magnetic media, a magnetic disk drive for reading from and writing to a removable, non-volatile magnetic disk (e.g., a “floppy disk”), an optical disk drive for reading from and/or writing to a removable, non-volatile optical disk such as a CD, DVD, or other optical media, a flash memory device, and so forth. These storage device(s) and their associated computer-readable media provide storage of computer readable instructions, data structures, program modules, and/or other data for computing device 800.

User commands and other information can be entered into computing device 800 via one or more input/output (I/O) devices 810, such as a keyboard, a pointing device (e.g., a “mouse”), a microphone, a joystick, a game pad, a satellite dish, a serial port, a universal serial bus (USB), a IEEE 1394 bus, a scanner, a network interface or adapter, a modem, and so forth. Information and data can also be output by computing device 800 via one or more I/O devices 810, such as a monitor, a printer, a network interface or adapter, a modem, a speaker, and so forth.

An implementation of the community program ratings described herein may be described in the general context of processor-executable instructions or computer-executable instructions, such as program modules, executed by one or more computing devices. Generally, program modules include routines, programs, objects, components, data structures, etc. that perform particular tasks or implement particular abstract data types. Typically, the functionality of the program modules may be combined or distributed as desired in various embodiments.

An implementation of the community program ratings may be stored on or transmitted across some form of computer readable media. Computer readable media or processor-readable media can be any available media that can be accessed by a computer. By way of example, and not limitation, computer readable media or processor readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD, digital versatile disks. (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RE, infrared, and other wireless media. Combinations of any of the above are also included within the scope of computer readable media.

Alternatively, all or portions of these modules and techniques may be implemented in hardware or a combination of hardware, software, and/or firmware. For example, one or more application specific integrated circuits (ASICs) or programmable logic devices (PLDs) could be designed or programmed to implement one or more portions of the framework.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer readable media having stored thereon a plurality of instructions that, when executed by one or more processors, causes the one or more processors to:
receive a rating from a user for a program;
identify whether the rating is a private rating for the user or is a rating that can be accessed by a plurality of other users; and
send the rating and an indication of whether the rating is a private rating for the user or is a rating that can be accessed by a plurality of other users to a community rating system for storage.

2. One or more computer readable media as recited in claim 1, wherein the plurality of instructions further causes the one or more processors to, if the rating is a rating that can be accessed by a plurality of other users, identify which of the plurality of other users can access the rating.

3. One or more computer readable media as recited in claim 2, wherein to identify which of the plurality of other users can access the rating is to receive an input from the user identifying a community of the plurality of other users, and wherein all of the plurality of users that are part of the community can access the rating.

4. One or more computer readable media as recited in claim 1, wherein the program is part of a series of programs, and wherein the rating applies to all the programs in the series.

5. One or more computer readable media as recited in claim 1, wherein the rating comprises a selection of a value of a rating scale, and wherein the instructions further cause the one or more processors to:
receive from the user, in addition to the rating, comments regarding the program; and
send the comments to the community rating system for storage.

6. A method comprising:
receiving a request for a rating of a community for a program;
accessing user ratings for the program, the user ratings being ratings previously submitted by users in the community that were not identified as being private; and
presenting the user ratings to a user.

7. A method as recited in claim 6, wherein presenting the user ratings to a user comprises displaying the user ratings in an electronic programming guide.

8. A method as recited in claim 6, further comprising consolidating the accessed user ratings into a single user rating, and wherein presenting the user ratings comprises presenting the single user rating to the user.

9. A method as recited in claim 6, further comprising receiving, from the user, an indication of which of a plurality of other users are to be included in the community.

10. A method as recited in claim 6, further comprising presenting, to the user, comments associated with the user ratings.

11. A method as recited in claim 6, wherein the request is a request for all ratings of all users of the community, and wherein the presenting comprises presenting all ratings of all the users of the community to the user.

12. A system comprising:
a rating storage system to:
receive, from a first client device, a rating for a program and an indication of whether the rating is a private rating for a user or is a rating that can be accessed by a plurality of other users; and
store, on a recording media, the rating and the indication;
a rating retrieval system to:
receive, from a second client device, a request for a rating of a community for the program;
access user ratings, stored on the recording media, for the program, the accessed user ratings having been previously submitted by users in the community; and
return, to the second client device, the user ratings that are not indicated as being private.

13. A system as recited in claim 12, wherein the rating storage system is further to, if the rating is a rating that can be accessed by a plurality of other users, receive an indication of which of the plurality of other users can access the rating.

14. A system as recited in claim 13, wherein the indication of which of the plurality of other users can access the rating comprises an indication of a community of the plurality of other users, and wherein all of the plurality of users that are part of the community can access the rating.

15. A system as recited in claim 12, wherein the program is part of a series of programs, and wherein the rating applies to all the programs in the series.

16. A system as recited in claim 12, wherein the rating comprises a selection of a value of a rating scale, and wherein the rating storage system is further to:
receive from the user, in addition to the rating, comments regarding the program; and
store, on the recording media, the comments.

17. A system as recited in claim 12, wherein the rating retrieval system is further to consolidate the accessed user ratings into a single user rating and return, to the second client device, the single user rating as the user ratings.

18. A system as recited in claim 12, wherein the rating storage system is further configure to receive, from the user, an indication of which of a plurality of other users are to be included in the community.

19. A system as recited in claim 12, further comprising returning, with the user ratings, comments associated with the user ratings.

20. A system as recited in claim 12, wherein the rating retrieval system is further to:
receive a request for all ratings of all users of the community;
access the user ratings for the program; and
return, to the second client device, the user ratings for all programs for all the users of the community.
